(19) United States
(12) Patent Application Publication
(10) Pub. No.: US 2016/0200934 A1
(43) Pub. Date: Jul. 14, 2016

(54) METHODS AND COMPOSITIONS FOR CELLULOSE EPOXIDE COMPOSITES

(71) Applicants: Georgia Tech Research Corporation, Atlanta, GA (US); THE UNITED STATES OF AMERICA AS REPRESENTED BY THE SECRETARY OF AGRICULTURE, Washington, DC (US)

(72) Inventors: James Carson Meredith, III, Marietta, GA (US); Natalie Girouard, Atlanta, GA (US); Gregory T. Schueneman, Madison, WI (US); Meisha Shofner, Atlanta, GA (US)

(21) Appl. No.: 14/990,293

(22) Filed: Jan. 7, 2016

Related U.S. Application Data
(60) Provisional application No. 62/101,232, filed on Jan. 8, 2015.

(51) Int. Cl. C09D 163/00

(52) U.S. Cl. CPC C09D 163/00

(57) ABSTRACT

Embodiments of the present disclosure provide for compositions and methods of making a waterborne epoxide resin that contains cellulose nanocrystals or nanofibrils.

### CROSS-REFERENCE TO RELATED APPLICATIONS

This application claims the benefit of and priority to U.S. Provisional Application Ser. No. 62/101,232, filed on Jan. 8, 2015 having the title “Commercial Utilization of CNCs as Stabilizing Pot-Life Extender in Epoxy Coating Formulations” which is incorporated herein by reference.

### STATEMENT REGARDING FEDERALLY SPONSORED RESEARCH

This invention was made with Government support under contract 11-JV-11111129-117 awarded by the United States Department of Agriculture. The Government has certain rights in the invention.

### BACKGROUND

A commercial epoxide formulation can include an epoxide precursor that is present as a surfactant-stabilized particle dispersion in water, to which a diamine crosslinker is added to initiate curing prior to the coating. This two-stage addition process is a practical challenge that requires extra time and equipment for the user. Thus, there is a need to overcome the disadvantages of commercial waterborne epoxy coatings.

### SUMMARY

Embodiments of the present disclosure provide for compositions and methods of making a waterborne epoxide resin that contains cellulose nanocrystals.

An embodiment of the present disclosure includes a method of making a waterborne epoxide resin that includes: mixing an epoxide suspension with cellulose to form mixture A; stirring mixture A for about one hour or more; and adding a protic crosslinker to mixture A and further stirring to form mixture B. In addition, the method can include making an epoxy/cellulose composite film by: precuring mixture B at room temperature, casting the mixture onto a silicon wafer solid substrate, and curing the coated substrate in an oven to form the epoxy/cellulose film.

An embodiment of the present disclosure includes a method of making an epoxy/cellulose composite film that includes: precuring mixture B noted above at room temperature, casting the mixture onto a silicon wafer solid substrate to form a coated substrate, and curing the coated substrate in an oven to form the epoxy/cellulose film.

An embodiment of the present disclosure includes a composition that includes: a waterborne epoxide resin formed by: mixing an epoxide suspension with aqueous cellulose suspension to form mixture A; stirring mixture A for about one hour or more; adding a protic crosslinker to mixture A and further stirring to form mixture B (two step mixing), wherein the wherein the cellulose is about 0.01-20 wt. % of the of the waterborne epoxide resin, and a work of fracture of about 50-150% greater than an epoxy formed using a single-step mixing process, and exhibits lower birefringence than the epoxy formed using a single-step mixing process.

An embodiment of the present disclosure includes a composition that includes: a waterborne epoxide resin formed by: mixing an epoxide suspension with freeze-dried cellulose as a powder to form mixture A; stirring mixture A for about one hour or more; adding a protic crosslinker to mixture A and further stirring to form mixture B, wherein the waterborne epoxide has a pot life of about 30 days or longer than waterborne epoxide formed using a single-step mixing process.

Other methods, composition, features, and advantages will be or become apparent to one with skill in the art upon examination of the following drawings and detailed description. It is intended that all such additional composition, methods, features and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 is a TEM image of wood derived CNCs used in the present disclosure.

FIG. 2 is an image of neat epoxy and nanocomposite films following curing. The films made by both methods appear transparent but colored.

FIG. 3 shows polarized light microscopy images of epoxy/CNC composites. Top: one-step mixing, bottom: two-step mixing.

FIGS. 4A-B ATR-FTIR spectra of films made by one-step and two-step mixing for a 5 wt. % cured composite, (4A) 3100-3600 cm-1 (4B) 1000-1100 cm-1.

FIG. 5 shows the zeta potential curve for epoxy precursor and CNC dispersions as a function of volume fraction of CNC (vf. CNC).

FIG. 6 is an FE-SEM image of an epoxy particle coated with CNCs. Scale bar is 100 nm.

FIG. 7 shows FE-SEM images of a 5 wt. % composite fracture surface. Top: one-step mixing Bottom: two-step mixing, scale bar is 1 μm.

FIG. 8 plots the onset temperature of thermal degradation as a function of CNC concentration.

FIGS. 9A-B illustrate the storage modulus of (9A) 5 wt. % and (9B) 10 wt. % CNC composite made by one- and two-step mixing. 0 wt. % CNC for comparison.

FIGS. 10A-B illustrate the loss modulus of (10A) 5 wt. % and (10B) 10 wt. % CNC composite made by one- and two-step mixing.

FIGS. 11A-B illustrate (11A) tensile strength and (11B) work of fracture for 0, 5, and 10 wt. % CNC samples made by one- and two-step mixing.

FIG. 12 is an FTIR spectrum showing the extent of curing in epoxy with freeze-dried CNCs.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, material science, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

### DEFINITIONS

Cellulose nanocrystals (CNCs), sometimes referred to as cellulose nanowhiskers or nanocrystalline cellulose, as used herein, are highly-crystalline sections of cellulose that are isolated from bulk cellulose by mechanical or chemical treatment to separate amorphous from crystalline regions, including methods such as acid hydrolysis, oxidation, homogenization, and grinding. They are characterized by a diameter of about 5-10 nm and lengths of about 25 to 300 nm. Cellulose nanofibrils (CNFs) are another type of nanoscale fibrillar material that are isolated from bulk cellulose by mechanical or chemical means, and are usually characterized by larger average diameter (e.g., about 5-25 nm or greater than 10 nm or about 12 to 25 nm) and especially larger average lengths (e.g., about 100 to 1000 nm or about greater than 300 nm or about 350 to 1000 nm) than CNCs, and are often entangled with one another.

Epoxide resins, as used herein, are a group of thermosetting polymers or prepolymers formed from monomers or prepolymers containing epoxide groups. Epoxide resins have been widely used in adhesives, coatings, composites, electric systems, and marine aerospace applications. Epoxide resins have epoxide (cyclic ether oxirane) groups that can be reacted with a variety of curing agents that contain amine, hydroxyl, carboxyl, and thiol groups to make flexible or rigid materials.

The glass transition temperature (TO, as used herein, is the temperature at which a liquid-like polymer or epoxide resin becomes glassy during cooling, and is defined by sudden changes in calorimetric, volumetric or mechanical properties associated with a loss of molecular segmental motion.

### General Discussion

Embodiments of the present disclosure provide for compositions and methods of making a waterborne epoxide resin that contains cellulose nanocrystals. Advantages of an exemplary method of the present disclosure include improved CNC dispersion, improved mechanical properties of final cured materials, improved stability, slower cure time, and longer shelf life than either neat epoxide resins or epoxide resins formed by adding CNCs along with curing components in a single step during formation of the waterborne epoxide resin. The dispersion of CNCs in the present disclosure is more homogenous than that of previous methods.

Embodiments of the present disclosure can be advantageous in that CNCs are sustainable and their addition to waterborne resins produces lower volatile organic compound emissions in comparison with resins made with non-aqueous solvents. Other advantages of the present disclosure provide for a one-part formulation in which curing is delayed until the time of coating, reducing the need for mixing on the part of the consumer, and reduced cleaning time and waste at the manufacturer. The present disclosure provides for a composition that shows delayed curing properties at low temperatures, but does not prevent curing reaction from occurring under all conditions. Epoxy-CNC or epoxy-CNF composites formed after curing the epoxide resin of the present disclosure exhibit low birefringence and improved stiffness, tensile strength, and work of fracture below the glass temperature. Potential applications of the material include paints, metal coatings for aircraft, automotive and architecture, treatments for damp concrete, and numerous others.

An embodiment of the present disclosure provides for a method of making a CNC-epoxide composite, comprising a first step of mixing an aqueous epoxide suspension with an aqueous suspension of CNCs for about one hour or more (e.g., about 1 to 3 hours). Stirring can be performed using magnetic stirring or other mechanical stirring, including homogenization and/or application of ultrasound. In a second step, a protic crosslinker (curing agent) (e.g., an amine crosslinker) can be added and the composite material is further stirred to form the waterborne epoxide resin.

An embodiment of the present disclosure provides for a method of making a composition that includes cellulose nanocrystals. In an embodiment, the waterborne epoxide resin contains about 0.01-5 wt. %, about 0.01-10 wt. %, about 0.01-15 wt. %, or about 0.01-20 wt. % of CNC.

In an embodiment, the CNC is an aqueous suspension prepared by sulfuric acid digestion of wood pulp. The suspension can have a CNC wt. % of about 1-10 wt. %. In an embodiment, the CNCs can contain about 0.01-1 wt. % of sulfur. In an embodiment, the CNC is freeze dried wood pulp prepared by sulfuric acid digestion. The CNCs can contain about 0.1-1 wt. % of sulfur.

In an embodiment, the epoxide precursor can be suspended as an aqueous surfactant-stabilized emulsion or particle dispersion. In an embodiment, the epoxide precursor can be bisphenol-A or bisphenol-F diglycidyl ethers, epoxy phenol novolacs or epoxy cresol novolacs, aliphatic or cycloaliphatic epoxides, and glycidyl amines. In a particular embodiment, the epoxide precursor is diglycidyl ether of bisphenol-A (DGEBA), with an epoxy equivalent weight of 550 g/mol.

In an embodiment, the protic crosslinker can be an amine, hydroxyl or carboxyl-containing molecule. The protic crosslinker can be based on phenols, anhydrides, aromatic or aliphatic amines, carboxylic acids or acid anhydrides or thiols. In a particular embodiment, the amine crosslinker can be poly(oxypropylenediamine), with an amine hydrogen equivalent weight of 200. The solute wt. % in deionized water is about 10-80 wt. %, about 15-50 wt. %, or about 20-40 wt. %.

In an embodiment, the epoxide precursor and the protic crosslinker are added in stoichiometric amounts, where the epoxide and protic crosslinker are present in a ratio of about 1:1, or nearly stoichiometric amounts of about 0.9:1.1 to 0.99:1.01, or about 0.95:1.05 to 0.99:1.01. In an embodiment, the epoxide precursor and the amine crosslinker are added in stoichiometric amounts, where the epoxide and amine are present in a ratio of about 1:1, or nearly stoichiometric amounts of about 0.9:1.1 to 0.99:1.01, or about 0.95:1.05 to 0.99:1.01. The CNCs can comprise about 0.01-5 wt. %, about 0.01-10 wt. %, about 0.01-15 wt. %, or about 0.01-20 wt. % of the final cured polymer composition.

The two step process produces an improved nanoparticle dispersion in which CNCs were premixed with the waterborne epoxide resin, compared to the one-step mixing of the waterborne epoxide resin, protic crosslinker (e.g., amine crosslinker), and CNCs. The stability of the waterborne system and resulting structure and properties are significantly improved by the pre-addition of CNCs, which may be attributed to a more intimate association of CNC particles with the surfactant-stabilized epoxide precursor droplets allowed by the premixing step. The zeta potential measurements of CNC mixtures with waterborne epoxide at various CNC concentrations illustrate the improved stability. Time-resolved ATR-FTIR measurements and observations of viscosity of waterborne epoxide mixtures with CNC and amine also illustrate improved pot life (e.g., from a standard pot life of only a few hours without CNCs to an improved pot life of 30 to 130 days with added CNCs) in the case of addition of freeze-dried (powder) CNCs. The improved CNC dispersion observed led to better mechanical performance in the glassy region of the storage modulus curve, increased work of fracture, and retained its thermal stability.

In an embodiment, the epoxide resin has a pot life of about 30 days or longer (e.g., about 30 to 130 days) when freeze-dried CNCs are added in the pre-addition step, where pot life refers to time after addition of crosslinker during which the formulation remains a workable liquid that can be cast, sprayed or otherwise formed into a desired shape under storage temperatures of about 20-28° C. The extension in pot life is observed when freeze-dried CNCs are added in a powder form during the pre-addition step.

In an embodiment, the tensile strength of the epoxy/CNC composite film formed after curing the epoxide resin with amine and CNC can be about 60 MPa or more (e.g., 60 to 100 MPa). In an embodiment, the glass temperature (TO can be about 75.5° C. (e.g., about 65 to 80° C.). The stiffness of the epoxy/CNC composite is improved below the glass temperature in comparison to both resins formed using a single-step mixing process and resins formed from a neat matrix containing only an epoxide suspension and a protic crosslinker (e.g., an amine crosslinker).

In an embodiment, the epoxide resin mixture can be precured at room temperature for about 0.5-2 hours to increase viscosity to aid in coating onto a substrate. The epoxide resin mixture can be cast or sprayed onto a substrate and further precured at room temperature. The epoxide resin on the substrate can then be cured at a temperature of about 100° C.-120° C. for about 1 to 3 hours or about 2 hours to form a film. In an embodiment, the thickness of the film can be about 1 to 200 μm, or about 5 to 100 μm or 5 to 25 μm.

### Examples

In the present disclosure, cellulose nanocrystals (CNCs) or cellulose nanofibrils (CNFs) are incorporated into a waterborne epoxide resin following two processing protocols that vary by order of addition. The processing protocols produce different levels of CNC dispersion in the resulting composites. The epoxy/CNC composite formed from curing the resin produced with a two-step protocol is more homogeneously-dispersed and has a higher storage modulus and work of fracture at temperatures less than the glass transition temperature. Some properties related to the component interactions, such as thermal degradation and moisture content, are similar for both composite systems. The mechanism of dispersion is probed with electrophoretic measurements and electron microscopy, and based on these results, it is hypothesized that CNC preaddition facilitates the formation of a CNC-halo around the epoxy droplet, promoting CNC dispersion and giving the epoxide droplets added electrostatic stability. Furthermore, when freeze-dried CNCs are added instead of aqueous CNC suspensions, the structural changes in polymer network formation results in an extension of the epoxide and crosslinker mixture's pot life by three orders of magnitude relative to a single step process of making the waterborne epoxy resin.

Several studies have detailed the phenomenon of colloidal haloing^{12,13} and a large body of literature has defined and explored the broader field of Pickering emulsions.^{8, 11} In Pickering emulsions, stabilization of a liquid droplet involves particles that are strongly adsorbed to the liquid-liquid interface, which provide a mechanical barrier to droplet coagulation. Colloidal haloing is the stabilization of large drops or particles by much smaller particles, where the two particles have high charge asymmetry. The smaller particles are not directly adsorbed on the larger particle interface, but maintain a separation distance a few nanometers from the particle or drop surface.¹³

The potential association of CNCs at interfaces offers intriguing possibilities for control of CNC-polymer interactions by changing the order of CNC addition, especially in multicomponent systems. The current example examines the effect of CNC order of addition on colloidal stability, CNC dispersion, and composite performance in a waterborne epoxy system. The particular resin chosen for this example can be applied as original equipment manufacturing protective coatings, as a floor sealer or paint, and as an anticorrosive primer.¹⁴ Additionally, a common issue encountered in the coatings industry is damp concrete, which can only be effectively coated by waterborne resins.¹⁵ Waterborne resins are also desirable for companies interested in reducing their volatile organic content emissions. In the commercial formulation we have selected for this study, the epoxide precursor is present as a surfactant-stabilized particle dispersion in water, to which a diamine crosslinker is added to initiate curing prior to the coating. This two-stage addition process is a practical challenge that requires extra time and equipment for the user, relative to a ‘one-part’ type of formulation. Discovery of ways to delay cure until the time of coating in a one-part formulation would be a significant practical advantage in waterborne epoxy coatings. A few publications have reported preparation of CNC-epoxy composites from waterborne resins.^{6, 16, 17} An advantage of these systems is that the CNCs are water-dispersable, reducing the need for surface functionalization. Here we report that a simple change in the order of CNC addition, involving adding the CNCs either before or during the diamine addition, alters significantly the manner in which the CNCs interact with the epoxide. The formulations resulting from pre-addition of CNCs prior to diamine have long pot lives, suggesting that they may be candidates for one-part coatings with long shelf-life (>1 month instead of a few hours).

### MATERIALS AND METHODS

A solid epoxide suspension (D₅₀=0.5 μm) in water (diglycidyl ether of bisphenol-A (DGEBA), Air Products and Chemicals, Inc., Ancarez AR555, epoxy equivalent weight (EEW)=550) was used as received. A water soluble amine crosslinker (polyoxypropylenediamine, Air Products and Chemicals, Inc., Anquamine 401, amine hydrogen equivalent weight (AHEW)=200) was diluted with approximately equal weight of deionized water to reduce the viscosity. The final solute content in the amine/water solution was approximately 35 wt. %. An 8.75 wt. % aqueous CNC suspension was provided by the U.S.D.A. Forest Service, Forest Products Laboratory, and the suspension was prepared from mixed southern yellow pine dissolving pulp via 64% sulfuric acid digestion as described elsewhere.¹⁸ The resulting CNCs had sulfate functionality due to residual sulfate esters on their surfaces. The CNCs were determined to contain 0.72 wt. % sulfur on a dry cellulose basis by inductively coupled plasma/optical emission spectroscopy (ICP/OES). A sample of freeze dried CNC material was also obtained from the U.S.D.A. Forest Service, Forest Products Laboratory. These particles were determined to contain 0.96 wt. % sulfur on a dry cellulose basis by the same method. The CNC/epoxy composite suspensions were cast onto treated silicon wafers for the final curing step. A 95 wt. % octadecyltrichlorosilane (OTS) solution was purchased from Acros Organics. Silicon wafers (300 mm diameter, double-side polished) were purchased from Silicon Valley Microelectronics, Inc.

Substrate Treatment and Film Preparation.

In order to prevent silanol groups (Si—OH) on the surface of the untreated silicon wafer from potentially reacting with the epoxide groups, the silicon wafers were treated with OTS¹⁹⁻²⁴ by a process described elsewhere¹⁷. This surface treatment rendered the silicon substrate hydrophobic and allowed for easy removal of the polymer film.

Film samples were prepared by two methods. In the first method, the epoxide suspension, amine crosslinker, and aqueous based CNCs were combined and magnetically stirred together at medium speed (Corning PC-200 stirrer), referred to as ‘one-step mixing’. In the second method, the epoxy suspension and aqueous based CNCs were combined and magnetically stirred at medium speed for 1 hour prior to crosslinker addition, referred to as ‘two-step mixing’. In both cases, stoichiometric amounts of epoxy and amine were used, and mixing was carried out at room temperature. Subsequent steps leading to film formation were the same for both methods. The nanocomposite mixture was precured for 0.5 to 2 hours at room temperature until the viscosity of the mixture increased enough to barely allow flow. Precuring times were determined by visual inspection and increased with CNC concentration since greater amounts of water, resulting from the CNC suspension, were present thereby diluting the reactive epoxy. The mixture was then cast onto the OTS treated silicon wafer substrate and dried at room temperature for 1-3 hours until the mixture was not able to flow. The coated substrates were then transferred to an oven and cured for 2 hours at 100° C., or 120° C. (10 and 15 wt. % CNC samples only). Neat epoxy samples were prepared using the same processing protocols for comparison. As a control for the two-step mixing procedure, the neat sample was prepared by first magnetically stirring the epoxy suspension for 1 hour followed by addition of the amine crosslinker and additional mixing. The final thickness of the neat epoxy and nanocomposite films was approximately 150 to 200 μm. Optical, thermal, and mechanical characterization described below was carried out on nanocomposite films made with the aqueous based CNCs.

Transmission Electron Microscopy.

To observe the morphology of the CNCs, the as-received CNC/water suspension was diluted with DI water to a concentration of 0.1 wt. % and deposited onto a 400 mesh carbon grid with a Holey carbon support film. In order to enhance contrast, the samples were stained with a 2 wt. % aqueous solution of uranyl acetate. Samples were then imaged using a Philips CM-100 TEM (FEI Company, Hillsboro, Oreg.) at an accelerating voltage of 80 kV. The CNCs dimensions were analyzed using the image analysis software Image J, a total of 14 particles were measured and average values were reported.

Polarized Optical Microscopy.

The level of CNC dispersion achieved by the two processing methods in the epoxy matrix was investigated qualitatively by the observation of birefringence with an optical microscope (Olympus BX51) equipped with two polarizers (Olympus U-AN360P). Images were captured with an Olympus camera (U-CMAD3) and processed with PictureFrame software. All films were imaged in transmission mode with a 20× objective and at full extinction of the polarizers.

Fourier-Transform Infrared Spectroscopy.

The chemical structure of cured film samples was characterized by Fourier transform infrared (FT-IR) spectroscopy using an attenuated total reflectance (ATR) accessory (Bruker Vertex 80V, equipped with Hyperion 20× ATR objective). The spectra were corrected by subtracting the background signals and flattening the baselines. The wavenumber scan range was 4000 cm⁻¹ to 600 cm⁻¹ with a resolution of 4 cm⁻¹ and a total of 64 scans. The epoxy precursor contains aromatic rings which were assumed to not participate in the reaction. Aromatic rings absorb in the 1600-1470 cm⁻¹ region, specifically at 1600, 1580, 1470, and 1510 cm⁻¹.²⁵ All of these peaks were present for both the epoxy precursor and the cured neat polymer thus confirming that these functional groups do not react in this system. The FTIR spectra were normalized by the absorbance at 1510 cm⁻¹, a peak common to all samples and unaffected by the chemical reactions or interactions. All figures represent normalized data.

The liquid nanocomposite mixture and individual components in solution were analyzed using liquid ATR-FTIR with a Bruker Platinum ATR accessory. The aqueous CNC dispersion was first freeze dried for this experiment, to avoid the effects of additional water from the CNC dispersion being added to the solution and thus diluting the reactive amine and epoxide in the IR.

Zeta Potential.

The epoxide suspension and aqueous CNC suspension were mixed together for several hours and then diluted. The volume fraction of epoxide was held constant while the volume fraction of CNC was varied. The zeta potentials of neat CNCs and neat epoxide suspension were also measured. The measurements were performed using a Malvern Zetasizer Nano ZS 90. Measurements were performed in triplicate at 25° C., and the average values were reported. The same instrument was used to measure the size of the epoxide particles in light scattering mode.

Field Emission Scanning Electron Microscopy.

To observe the component interactions in the two-step processing method, the CNC/epoxide suspension were imaged with field emission scanning electron microscopy (FE-SEM). To prepare the sample, the epoxide suspension and aqueous CNC suspension were mixed together for several hours and then diluted. The sample was then lyophilized for suitable imaging. The resulting product of the freeze drying process was adhered to carbon tape and sputter coated with a thin layer of gold. The samples were imaged by FE-SEM (Zeiss Ultra60). The morphology of cured polymer fracture surfaces were also examined with FE-SEM (Hitachi SU8010). These samples were not sputter coated and imaged at 0.9 kV.

Differential Scanning Calorimetry.

The values of the glass transition temperature (T_{g}) for the fully cured neat epoxy and composite films were measured by differential scanning calorimetry (DSC) (TA Instruments DSC Q200). In the first step, samples were heated from 30° C. to 150° C. at a rate of 10° C./min and then held at that temperature for 2 minutes. The samples were then cooled to 0° C., held for 2 minutes, and subsequently heated to 150° C. at a rate of 10° C./min. Data from the first and second heating step were used to obtain the T_{g} of the sample. The value of T_{g} was assigned as the midpoint of the transition region between the glass and rubber line on the heat flow curve using TA Universal Analysis Software. An exothermic/cure peak was not observed for any of the samples tested here, only a broad evaporation peak around 100° C. which was due to residual moisture left in the samples. The moisture content of the samples was quantified with thermogravimetric analysis (TGA). Measurements were performed three times on fresh samples for each material composition, and average data were reported.

Thermogravimetric Analysis.

Water absorption, thermal stability and changes in degradation patterns associated with CNC addition and processing were assessed with TGA (TA Instruments TGA Q5000). Samples were heated from room temperature to 120° C. at a rate of 10° C./min under a flowing nitrogen atmosphere and then held at that temperature for 20 minutes. In the final step, samples were heated to 600° C. at a rate of 10° C./min. The water absorbed by samples was measured as the weight loss during the first two steps. The thermal stability and decomposition patterns of the samples were obtained from the last step. The onset temperature and temperature at maximum weight loss were determined with TA Universal Analysis software. Measurements were repeated three times, and average values were reported.

Dynamic Mechanical Analysis.

The storage and loss moduli of the materials was determined from dynamic mechanical analysis (DMA) experiments (Mettler Toledo DMA/SDTA861). Samples were made by cutting films into strips a few centimeters long and 2.5-3 mm wide. The sample length was trimmed after the samples were mounted, resulting in a testing length of 9 mm. Samples were tested in tension mode in the linear viscoelastic regime for the materials. The linear viscoelastic regime was determined by strain sweep tests at the lowest and highest temperatures to be used during the test. The tests were conducted at a frequency of 1 Hz, over a temperature range of 30° C.-150° C., and at a heating rate of 2° C./min. Measurements were repeated three times, and average values were reported. Additionally, T_{g} values were obtained from the peak of the loss modulus curve.

Tensile Testing.

Uniaxial tensile testing was performed using an Instron 5842 testing frame equipped with a 100 N load cell. The samples were prepared by die cutting the films with a dog bone template based on the ASTM standard D1708-13. The specimens were strained at a rate of 0.5 mm/minute. Tensile strength, % elongation, and toughness data were obtained. A minimum of four samples were tested for each material composition, and the average values were reported.

### Results and Discussion

Morphology of CNC.

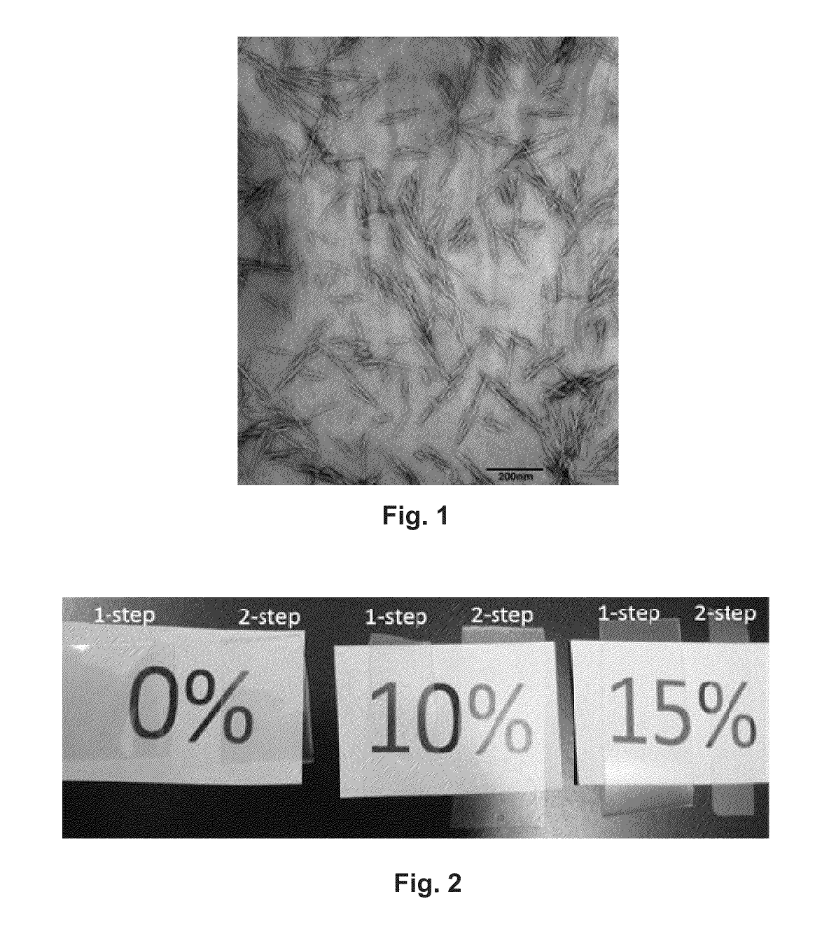

The dimensions of individual CNC particles were observed using TEM. FIG. 1 shows a representative TEM image of CNCs used in this work. Literature has shown that wood based CNCs have a square cross section¹ and thus, the CNC particles were assumed to have a square cross section. From image analysis, the average length and width of the CNCs were 138±22 and 6.4±0.6 nm, respectively, similar to those reported in a previous study.¹⁷ Based on these average dimensions, the aspect ratio of the CNCs was estimated to be 22. The rod-like/whisker morphology and the geometric dimensions were consistent with data reported in the literature for CNCs obtained from wood.^{18,26,27}

Epoxy/CNC Films.

Composites up to 15 wt. % CNC were produced, and across all concentrations tested and for both mixing procedures, the materials retained a similar level of transparency to the neat matrix. FIG. 2 highlights this result, showing that films made by the one-step and two-step mixing methods were colored but transparent.

The dispersion level of the CNCs within the cured epoxy matrix for both processing methods was assessed with polarized optical microscopy. The images are given in FIG. 3. The neat material displayed limited birefringence, so birefringent domains observed in the composites were attributed to CNC aggregates. Composites with CNC loadings up to 15 wt. % showed varying degrees of birefringence and different domain sizes for the birefringent regions. These differences in birefringence were related to the processing method and the CNC loading. For the samples made by one-step mixing, the size of the CNC domains was on the order of tens of microns. Larger aggregates were present in lower concentration samples compared to higher concentration samples. This effect was attributed to the longer mixing times used to prepare the 10 and 15 wt. % samples. Since more water was introduced into these samples with CNC addition, longer mixing times were required to attain the viscosity needed for proper precuring. The longer mixing times resulted in a better level of CNC dispersion. For films made by the two-step process, the CNCs had improved dispersion at all loadings tested with respect to those made by the one-step process. The 2 wt. % composite produced by the two-step method displayed almost no birefringence while higher loadings contained CNC domains. These domains were smaller in size and their brightness was less intense than the domains seen in composites made by one-step mixing.

Although domains of CNCs larger than the length of visible light were observed in polarized light, all composites had a similar level of transparency with respect to the neat epoxy as shown in FIG. 2. This attribute was due to refractive index matching of the epoxy and CNCs. Landry et al. reported that the refractive index of sulfuric acid hydrolyzed cellulose was 1.499²⁸ and Cranston et al. reported the refractive index of cotton-derived CNCs to be between 1.51 and 1.55, depending on the measurement method and number of bilayers of alternating cellulose and poly(allylamine hydrochloride).²⁹ Epoxy polymers typically have a refractive index ranging from 1.515 to 1.565.³⁰ Thus, it is expected that the refractive index of this epoxy polymer is within this range and similar to that of the CNCs.

To assess the degree of cure and understand the chemical structure of the nanocomposites, FTIR spectra were measured for the nanocomposite components and the nanocomposites. For the epoxide prepolymer, the absorption band at 912 cm⁻¹ was associated with the unreacted epoxide group.³³ The disappearance of this band in the neat cured epoxy and all composites tested here indicated that all of the epoxide groups reacted during the curing cycle.

CNCs have the potential to react with the epoxide group. If this event does occur, an ether bond will form, a hydroxyl group from cellulose will be consumed and a different hydroxyl group will be created, linking the epoxide monomer to the CNC surface. Additionally, the hydroxyl groups from cellulose can form hydrogen bonds with the epoxide group.

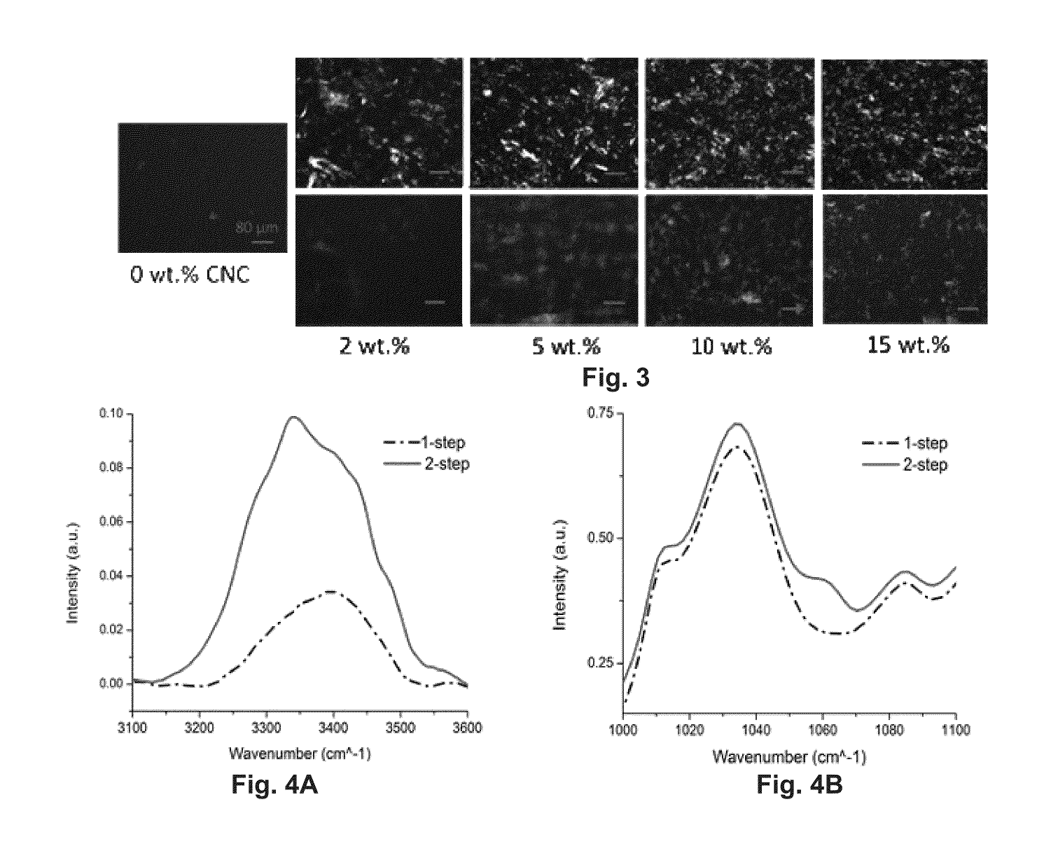

Differences in the FTIR spectra were observed for films made by the one-step and two-step methods. Portions of the spectra highlighting these differences are shown in FIG. 4. First, an increase in intensity was observed in the 3200-3600 cm⁻¹ region for the composites produced by the two-step method. The composites with improved CNC dispersion will inevitably have more interfacial area with the polymer matrix, and the exposed CNC surface hydroxyls likely have different infrared absorption characteristics (extinction coefficient, shift in wavenumber) than hydroxyls that are buried within CNC aggregates. For example, in addition to the increased intensity, a shift in the peak maximum was observed from 3400 cm⁻¹ for the one-step method to 3330 cm⁻¹ for the two-step mixed. A peak shift towards lower wavenumbers could indicate the presence of increased hydrogen bonding between CNCs and the polymer matrix in the two-step samples, which appears to correspond with the enhanced CNC dispersion.³⁴

Second, a new peak was observed at 1060 cm⁻¹ for the two-step mixed samples. This band appears to be evidence of a new ether bond. Two other possible assignments for this band include a primary aliphatic alcohol, which would be present in this system before and after an epoxy/cellulose reaction, or the glycosidic bond in cellulose, which is sometimes obscured in the infrared spectrum.²⁵ The evolution of this band as a function of time was monitored with liquid ATR-FTIR, and it was found that the intensity increased as reaction time increased. This observation indicates higher concentrations of this bond as the reaction progressed. This absorption was not present for the neat sample tested under the same conditions thus indicating that the presence of CNCs was responsible for these changes. While these changes are obvious, it is difficult to discern the functional group(s) responsible since absorbance in this region of the spectrum is likely due to a number of functional groups present in the cured composites.

Chemical analysis of this CNC/epoxy system was not trivial since most of the absorbances present in the reactants were also present in the final cured composite, and similar functional groups were present in all components. Nevertheless, the possibility of hydroxyl-containing CNC particles reacting with the epoxide group was ruled out when no change in the intensity of the oxirane vibration at 912 cm⁻¹ was observed before and after heating the epoxy-CNC suspension at 100° C. for 1 hour. Therefore, an altered stoichiometry is not responsible for the changes reflected in the composites made by the two processing methods, the effect is purely a physical one.

Size and Charge Measurements.

The zeta potential of a 0.01 wt. % CNC suspension was measured to be −71 mV, indicating that the CNCs were well-dispersed in water and largely isolated from one another. The negative charge was expected due to the sulfate ester functionality present on the CNC surface, leading to double-layer repulsion between particles. Due to the high magnitude of the zeta potential for the CNC suspension, a highly stable suspension was expected. The zeta potential of a 0.05 wt. % aqueous epoxide prepolymer suspension was measured to be −20 mV, a low charge that indicated a significantly lower kinetic stability than the −71 mV measured for the CNCs, and −68 mV for the V_{CNC}=1×10⁻⁴ CNC-containing epoxy droplets. Additionally, the size of the epoxide drop was measured with this instrument, indicating that the average diameter was 484±63 nm, in agreement with the manufacturer's data.

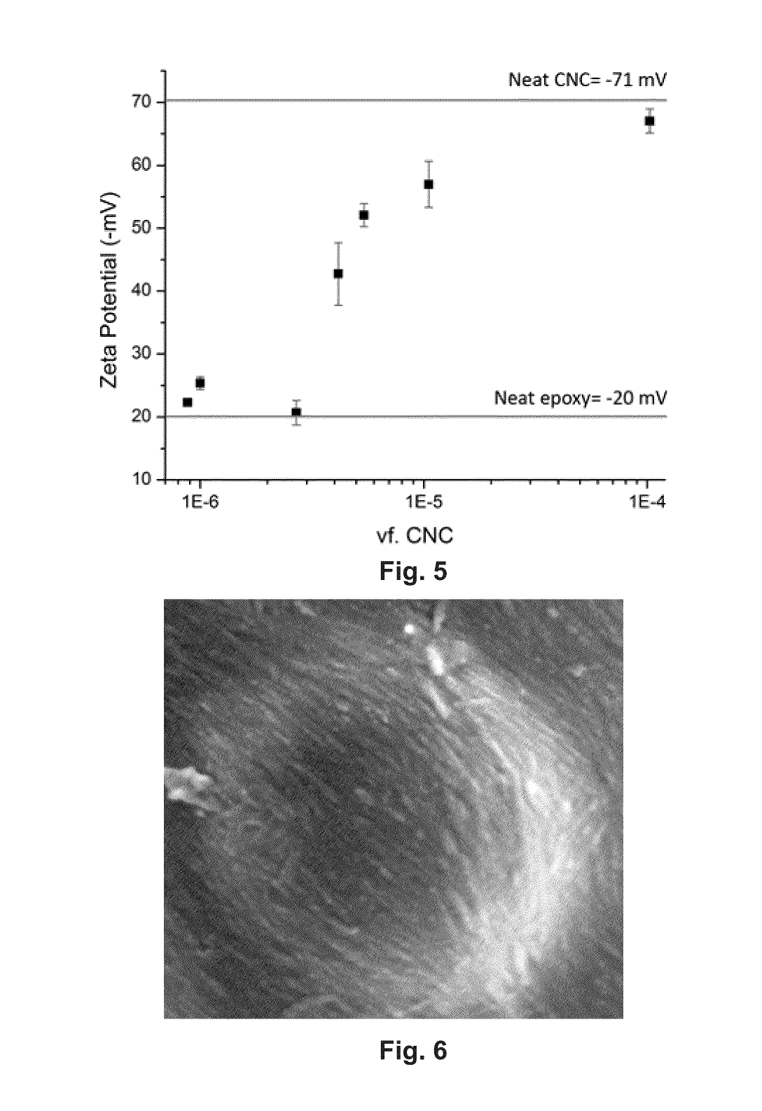

The zeta potential of the aqueous suspension consisting of the epoxide prepolymer with varying amounts of CNC is shown in FIG. 5. The volume fraction of epoxide remained constant at 5×10⁻⁵, while the CNC volume fraction was varied. At low volume fraction of CNCs, the zeta potential of the binary mixture remained close to the zeta potential of neat epoxide. As the CNC concentration increased, the zeta potential also increased, approaching the value for neat CNCs when the CNC volume fraction was 1×10⁻⁴. This result indicated that the CNC particles shielded the epoxide particles through either nanoparticle adsorption (Pickering emulsion) or a nanoparticle haloing effect. Since electrophoretic mobility is independent of size, this result implied that the epoxide particles and the CNCs moved in unison in response to the applied voltage, indicating that the two were associated.¹² This result supports the previous hypothesis that the CNCs associate around the epoxide droplet to hinder particle coalescence. Based on this information, it was also concluded that the CNCs imparted additional stability to the epoxide suspension. Similar results have been reported for silica microspheres stabilized by zirconia nanospheres,¹² a poly(butylmethacrylate) emulsion stabilized with cellulose whiskers³¹, and CaCO₃ nanoparticles stabilized by sodium dodecyl sulfate.³² Two possible explanations are colloidal haloing or nanoparticle adsorption directly at the epoxide-water interface (as in a Pickering emulsion), which are known to create the same behavior in zeta potential found to occur in the two-step samples.

It is important to note that while this result indicated that CNCs and epoxy precursors certainly had some interactions, it is difficult to specify those interactions for this system. This epoxy formulation is proprietary and thus some chemical information about the components is unknown. The molecular formula for the surfactant used to emulsify the epoxide is not given, so it is important to clarify that the CNCs may be interacting with the epoxy itself, the surfactant, or both.

Polymer Morphology.

The morphology of this CNC/epoxide configuration was further investigated with FE-SEM. A mixture of CNCs, epoxy, and water was mixed together for several hours, freeze dried, and imaged. This result is given in FIG. 6. The imaging indicated that a sphere consistent in size with the epoxy precursor was coated with a layer of CNCs. This result support the hypothesis that the CNC/epoxy premixing step leads to improved dispersion due to a more intimate association between the CNC and surfactant coated-epoxy particle.

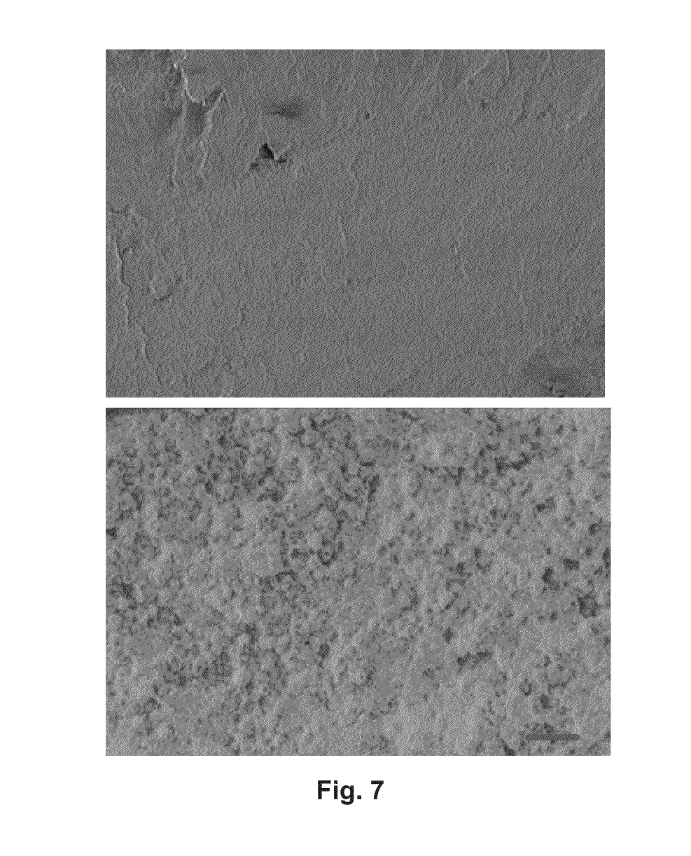

The morphology of the composite interface was also investigated with FE-SEM. The samples were fractured in ambient conditions, below T_{g} for the cured epoxy. FIG. 7 shows the fracture surfaces of 5 wt. % composites made by one-step and two-step mixing. The interface of the composite made by one-step mixing appeared smooth and represented that of a typical polymer surface which experienced brittle fracture. It should be noted that the micron-sized CNC domains did not appear in these images. The contrast observed between the CNCs and the epoxy resin with electron microscopy was low due to their similar electron density. The interface of the composite made by two-step mixing showed some noteworthy features. First, the two-step mixed sample was rougher than the one-step mixed sample. Second, this surface appeared to feature spherical particles. These particles were consistent in size with that of the epoxy precursor. Thus, for the two-step mixing case, the CNC particles appear to have preserved the epoxy as a separate phase rather than becoming a homogeneous matrix upon reaction with the amine. Although not intending to be bound by theory, we hypothesize that the CNCs are the cause of this effect with the likely mechanism being their surrounding the epoxy particle to form a barrier to epoxy droplet coalescence until the water has evaporated, preserving the shape of the original droplet. Another difference between these two interfacial morphologies was that the fracture surface of the sample produced by one-step mixing was relatively homogeneous throughout the observed area, whereas the fracture surface of the sample produced by two-step mixing was inhomogeneous with some areas containing spherical features while other areas are consistent with the sample produced by one-step mixing. This blend of morphologies is indicative of a transitional or intermediate state where most but not all of the epoxy particles have strong interactions with CNC prior to cure.

Thermal Properties of the CNC/Epoxy Films.

The values of T_{g} for composites made by the two processing protocols were determined with DSC experiments, and the results are shown in Table 1. The values of the T_{g} observed during the first heating cycle for all concentrations and processing methods were similar when considering confidence intervals. Thus, it was concluded that the mixing method and CNC content did not significantly affect the T_{g} of the samples following preparation. However, the measured T_{g} value obtained from a second heating cycle was affected by CNC content for samples prepared by the one-step mixing method. Similar to data reported previously by the authors,¹⁷ T_{g} increased by approximately 7° C. at a CNC loading of 10 wt. % after being heated to 150° C. during the first heating cycle. In contrast, the T_{g} values obtained for the samples produced by the two step mixing method were not appreciably affected by CNC content, though these values were higher than those measured from the first heating cycle. These differences are difficult to interpret precisely because of the larger confidence intervals for the materials produced by the 2-step method.

TABLE 1
Glass transition temperature values
with varied CNC concentration and processing method.

| | 0 wt. % CNC | | 5 wt. % CNC | | 10 wt. % CNC | |
|---|---|---|---|---|---|---|
| | 1-step | 2-step | 1-step | 2-step | 1-step | 2-step |
| First Heat | 48.6 ± 5.9 | 46.7 ± 0.7 | 46.1 ± 3.4 | 45.9 ± 3.5 | 50.6 ± 2.4 | 49.2 ± 1.8 |
| Second heat | 63.0 ± 1.8 | 60.6 ± 4.2 | 63.6 ± 1.5 | 62.0 ± 5.4 | 69.8 ± 1.1 | 61.9 ± 5.5 |

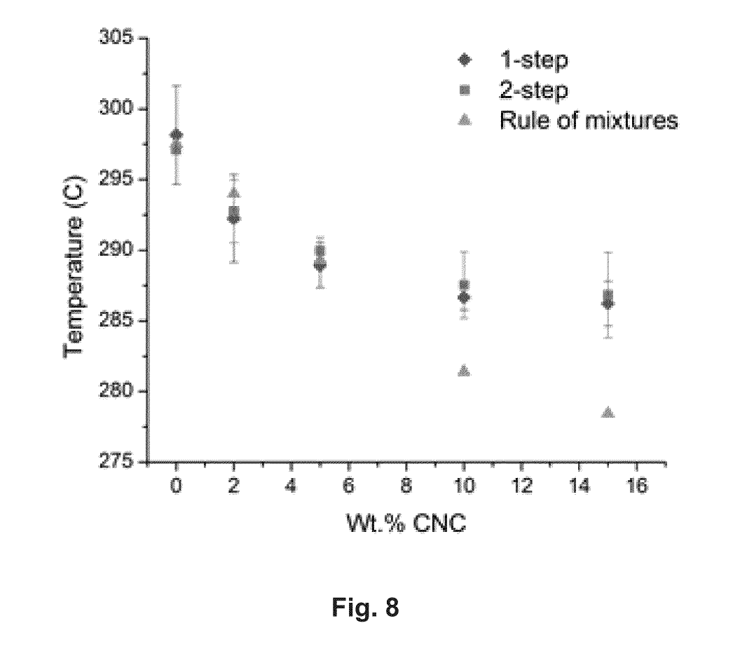

The thermal stability of the composites was tested with TGA, and the results are shown in FIG. 8. The onset temperature of thermal degradation was reduced with increasing CNC concentration. The bounding thermal degradation temperatures were established by the composite components. Neat epoxy began degrading at 297° C., and neat CNC began degrading at 208° C. There were no differences in degradation between composites made by one-step and two-step mixing. Compared to neat samples, while the CNCs did affect the initial degradation profile, the extent of the impact was not as great as expected at the higher CNC loadings. Employing rule of mixtures model, it was found that the onset degradation temperatures for the composites containing lower CNC loadings (<10 wt. %) were consistent with the prediction; however, this model predicted that the composites containing 10 and 15 wt. % CNC would have a lower onset degradation temperature than the experimentally measured value. This departure from the rule of mixtures suggested that the CNCs were integrated within the epoxy matrix, possibly through chemical bonds, for both processing scenarios.

The thermal degradation patterns of composites and neat epoxy occurred in two major steps, with the temperatures at maximum weight loss rates occurring at 335° C. and 385° C. Processing conditions as well as CNC content had little to no effect on the degradation patterns observed here. These two factors also had little to no effect on the water content of the samples, which was measured to be about 3 wt. % for all concentrations and processing methods tested here.

Mechanical Properties of the CNC/Epoxy Films.

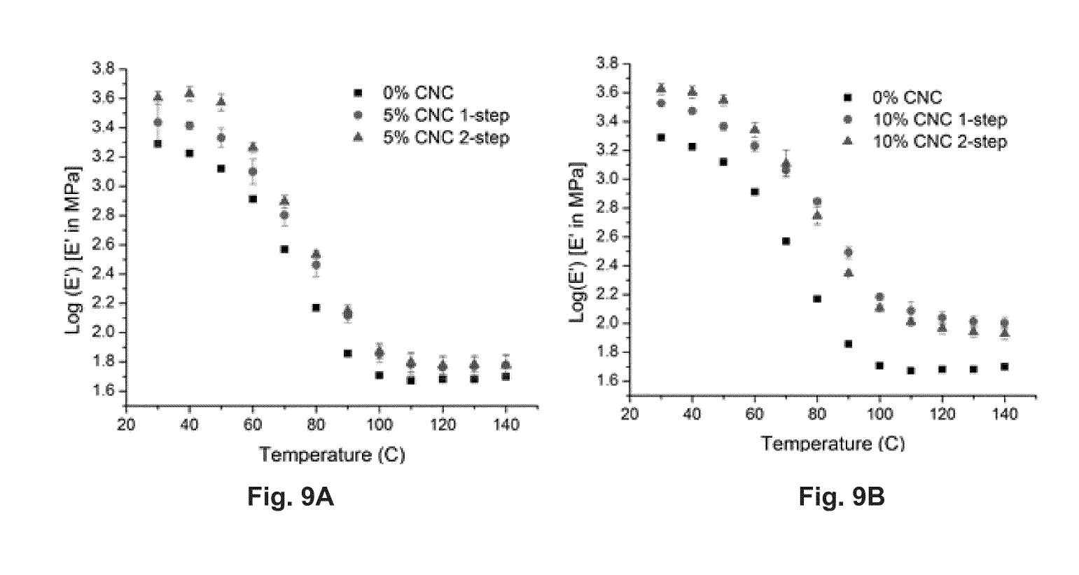

The thermomechanical performance of composites made by the two processing strategies was tested with DMA. The samples were tested in tension mode below and above Tg. Storage modulus (E′) data are shown for samples made by one- and two-step mixing in FIG. 9. These data suggested that the composites made by two-step mixing were reinforced more effectively than composites made by one-step mixing in the glassy region of the storage modulus curve, with improvements of 49% for the 5 wt. % composite and 30% for the 10 wt. % composite at 40° C. Comparing the composites to the neat matrix at 40° C., the 5 wt. % sample made by one-step mixing had an increase in the storage modulus of 47% while the sample made by the two-step mixing method had an increase of 91%. Similarly, the 10 wt. % sample was increased by 60% for the one-step mixing case and 86% for the two-step mixing case when compared to the neat matrix at 40° C. There were no significant differences in the rubbery modulus for composites made by either method. It is well known that CNCs can have profound effects on modulus, especially at temperatures greater than Tg.35-37 Other work in CNC/epoxy composites has shown dramatic increases in storage modulus above Tg with respect to the neat polymer due to the formation of a network of mechanically percolated nanofibers. The ability of a fiber to form a percolated network and thus have substantial impacts on rubbery modulus is a function of the aspect ratio and the volume fraction. Generally, the critical volume fraction required to form a percolated network is given by: Xc=0.7/AR.38 Results presented by Tang et al. showed a 69× increase in the rubbery storage modulus for CNCs extracted from tunicate (AR=84) and a 12× increase for CNCs extracted from cotton fibers (AR=10) in epoxy composites at a 15 wt. % loading (12 vol. %), a CNC loading above the critical volume fraction of 0.8 vol. % for the tunicate CNCs and 7 vol. % for the cotton CNCs.36 In the results presented here, much smaller gains in reinforcement were seen above Tg with respect to the neat polymer as compared to Tang et al. The different thermomechanical reinforcement trends were ascribed to differences in CNC network formation. In this work, a waterborne epoxy was used, and discrete birefringent domains of CNCs were observed in the composites. These results suggest large scale connectivity of individual nanofibers did not occur in these composites, even though the CNC loadings used were above the critical volume fraction.

While the processing method impacted the glassy mechanical properties preferentially, CNC addition had an effect on the storage modulus in the glassy and rubbery region when comparing the composites to the neat epoxy. As the temperature increased, the storage moduli for samples at different compositions began to deviate in the transition region at 50° C., and this deviation continued into the rubbery region. The difference in the storage modulus values of the composites produced by both methods and the neat epoxy was greater with increasing CNC concentration, and these changes in rubbery storage modulus were similar for both mixing methods at a given CNC loading. For example, at a 5 wt. % CNC loading, the rubbery storage modulus was increased by 30% at 120° C., and for a 10 wt. % CNC loading, the rubbery storage modulus was increased by 70% at 120° C.

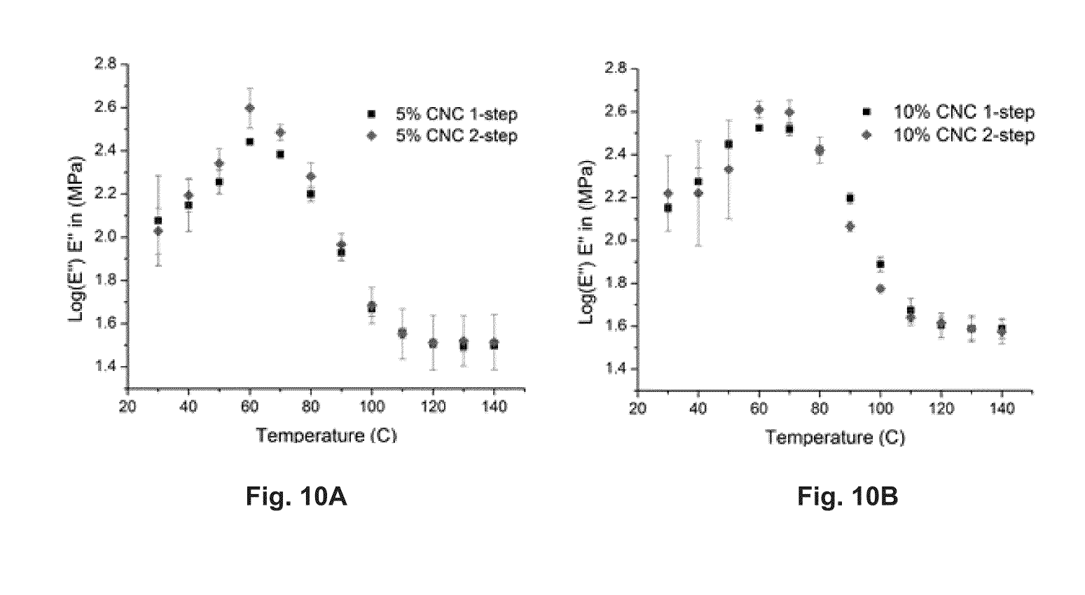

The loss modulus (E″) data comparing the two methods of preparation for a 5 and 10 wt. % composite are given in FIG. 10. Generally, the value of loss modulus increased with increasing CNC content, and the value of the loss modulus was similar for the composites of the same composition produced by the two methods, though there was some change in the magnitude of the loss modulus in the vicinity of the peak. However, these curves do not show significant differences in terms of peak shifts towards higher T_{g} with CNC content or processing method. The T_{g} values from DMA data would be most comparable to those obtained during the first heating cycle of the DSC measurements, where T_{g} was not different with processing or CNC concentration. Similar to the DSC data, there was a larger confidence interval in the measured value of the T_{g} for the samples made by the two-step mixing method.

To understand more fully what these data trends indicated about the reinforcement mechanism provided by the CNCs, the ratio of the loss and storage moduli, tan delta, was also examined. The values of tan delta were similar for composites containing the same amount of CNCs (data not shown). Since tan delta, and as a result the phase angle, were similar, the reinforcement seen was largely a result of increased CNC dispersion. While the FT-IR data suggest that there is an association between the CNCs and the matrix when the two-step mixing processing method is used, it does not appear to affect macroscale properties more than the differences in CNC dispersion since disproportionate changes in storage and loss modulus were not observed as a function of processing method.

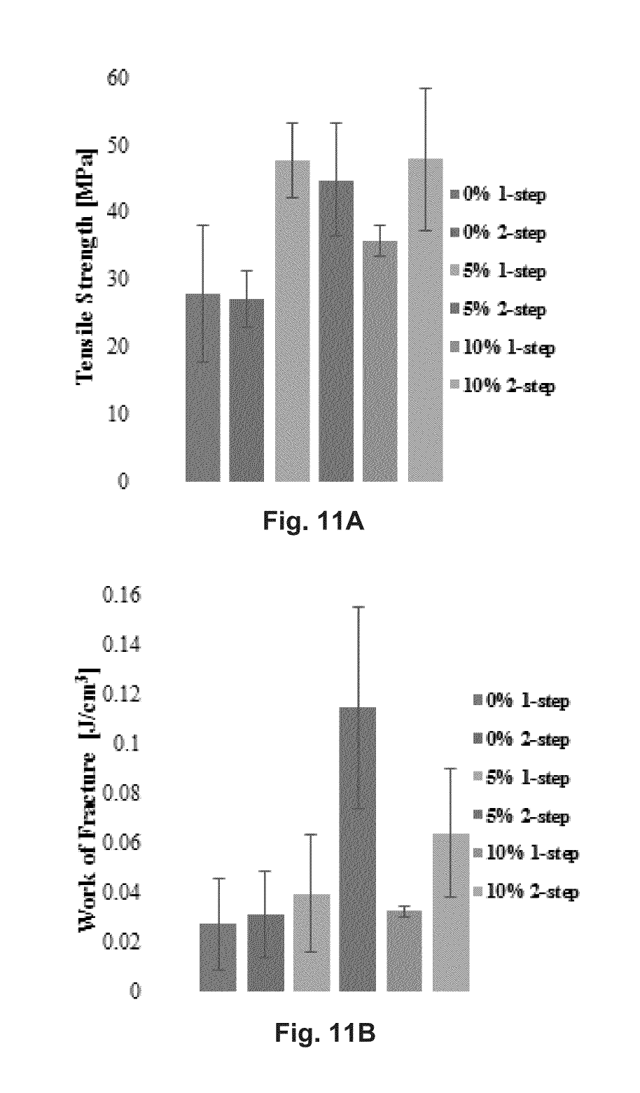

Tensile testing also provided insight into the reinforcing effect of CNCs as well as the effect processing had on mechanical properties. The tensile strength and toughness from work of fracture data for 0, 5, and 10 CNC wt. % samples made by the two processing methods is given in FIG. 11. The elongation at break was similar for all samples tested; therefore, the data are not shown. All samples experienced brittle fracture with an average elongation at break of about 4%.

Processing method was not found to affect the properties of the neat epoxy. Therefore, the delay in amine addition necessary for the CNC premixing step was not responsible for the changes observed in the composite samples, but rather the differences in morphology, level of CNC dispersion, and CNC-matrix interactions brought about by premixing the CNCs with the epoxy droplets before amine addition. The tensile strengths of the 5 and 10 wt. % CNC composites produced by one-step mixing were 47.7±5.6 and 35.8±2.4, respectively. The tensile strengths of the 5 and 10 wt. % CNC composites produced by two-step mixing were 44.9±8.5 and 48.0±10.6, respectively. These values were greater than those obtained for the neat epoxy produced by one-step and two-step mixing, 27.9±10.2 and 27.1±4.1, respectively. The data showed that CNC addition improved tensile strength at both loadings and with both processing methods studied in this work, but the differences between the tensile strengths for the composite samples were not statistically significant when considering the calculated confidence intervals. The effect of processing was more evident when considering the work of fracture data. In general, the samples made by the one-step mixing method and the neat epoxy samples had similar values for the work of fracture, with no differences observed with increasing CNC concentration. Conversely, the CNC/epoxy composites made by the two-step method exhibited increases in work of fracture of 93% and 67% compared to the sample made by the one-step method at the same concentration for a 5 and 10 wt. % composite, respectively. The difference in toughness between the samples produced by the two methods likely resulted from better CNC dispersion in samples produced by the two-step processing method. However, it is important to note here that the confidence interval was large. In general, the error range was larger for samples made by the two step method. As mentioned earlier, a hypothesis for the larger variations in the data is the inhomogeneous fracture morphologies observed in SEM for the samples made by the two-step method.

Pot Life Extension.

One potential application of the CNC-stabilized epoxide droplets was explored. In industrial applications, a practical concern is the large amount of water present in the CNC aqueous suspension. Addition of CNCs as a dry powder would be advantageous for practical reasons such as the avoidance of post-cure drying and reduced shipping costs for dry material. When 5 wt. % of the freeze dried CNC material was added to the epoxide suspension followed by amine addition, the pot life of the nanocomposite mixture was extended by three orders of magnitude when compared to that of the neat epoxy-amine mixture (1 month versus 2 hours). A substantially increased pot life enables the possibility of formulating one part waterborne epoxy coatings where the components are premixed and remain uncured for long periods of time until applied as a coating.

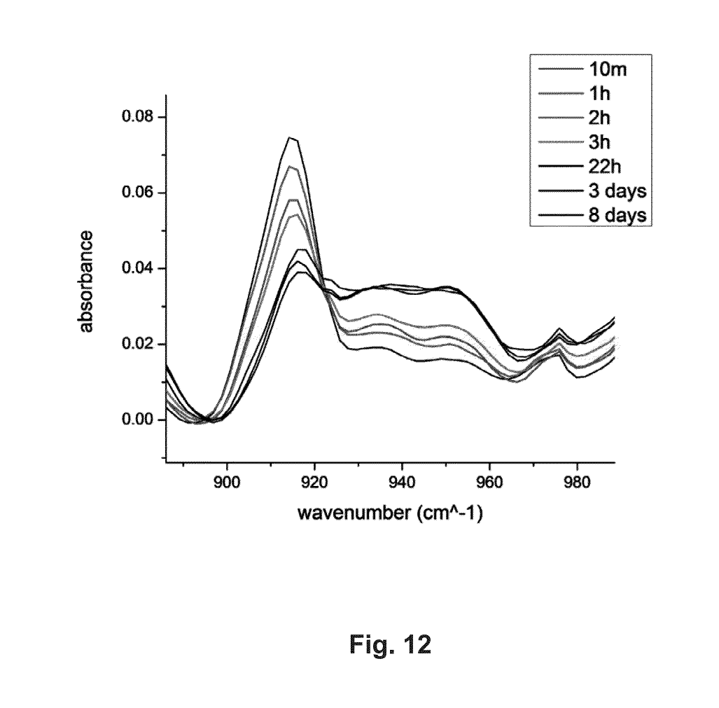

In this scenario, the presence of the CNC particles that were premixed with the epoxide suspension appears to prevent the aggregation of the epoxide particles, even though the epoxide and amine reaction had started to occur within them (confirmed by liquid ATR-FTIR indicating a decrease in 912 cm⁻¹ peak, FIG. 12). The extension of the gel time (pot life) to 30+ days may be a physical phenomenon resulting from the electrostatic stabilization conferred by the adsorbed CNCs. To explore this idea, we added NaCl to the CNC-stabilized epoxide/amine suspension. NaCl was added at 0.2 M to a stable mixture of freeze dried CNC, epoxide suspension and amine crosslinker prepared by the two-step mixture. Although the suspension was stable prior to salt addition, the system showed an immediate increase in viscosity (noted qualitatively) and eventually gelled after salt addition. These observations indicate flocculation of both CNCs and CNC-coated epoxy particles upon screening of the electrostatic charge imparted by the CNC particles to the epoxy particles.

### CONCLUSION

In these CNC/epoxy composites, improved nanoparticle dispersion was achieved by a two-step procedure in which CNCs were premixed with the epoxy precursor, compared to the one-step mixing of the epoxy precursor, amine crosslinker, and CNCs. The stability of the waterborne system and resulting structure and properties are significantly improved by the pre-addition of CNCs. Improved dispersion was attributed to a more intimate association of CNC particles with the surfactant-stabilized epoxy precursor droplets allowed by the premixing step, similar to stabilization mechanisms observed in colloidal haloing systems or Pickering emulsions. Evidence of the improved stability was supported by changes in the ATR-FTIR spectrum and zeta potential measurements of a CNC/epoxy mixture at various CNC concentrations. A change in the interfacial polymer morphology was observed with FE-SEM, with the improved dispersion composite featuring sphere-like structures consistent in size with the epoxy particles. The improved CNC dispersion observed in this study led to better mechanical performance in the glassy region of the storage modulus curve, increased work of fracture, and no changes in thermal stability. The CNC colloidal stabilization mechanism was expanded to incorporate freeze dried CNCs into the epoxy/crosslinker formulation, resulting in an extension of the pot life by three orders of magnitude compared to the neat system; a result that could potentially enable the formulation of one part epoxies. Based on this study, the authors believe that this work would be generally applicable to systems consisting of two reactive phases where one phase has both dispersing hydrophilic groups for CNC coordination and reactive groups, such as urethanes and acrylates. Overall, these results highlight the importance of understanding processing-structure-property relationships in CNC-containing nanocomposites as they are considered for higher volume applications and provide a path forward for further processing optimization.

### REFERENCES

(1) Moon, R. J.; Martini, A.; Nairn, J.; Simonsen, J.; Youngblood, J. Cellulose Nanomaterials Review: Structure, Properties and Nanocomposites. Chemical Society Reviews 2011, 40, 3941-94.
(2) “Critical Nanotechnology needs in the Forest Products Industry White Paper” Agenda 2020 Technology Alliance: Transforming the Forest Products Industry through Innovation 2009, 8.
(3) Dash, R.; Ragauskas A. J. Synthesis of a novel cellulose nanowhisker-based drug delivery system. RSC Advances 2012, 2, 3403-9.
(4) Junior de Menezes, A.; Siqueira, G.; Curvelo, A. A. S.; Dufresne, A. Extrusion and Characterization of Functionalized Cellulose Whiskers Reinforced Polyethylene Nanocomposites. Polymer 2009, 50, 4552-4563.
(5) Garcia de Rodriguez, N. L.; Thielemans, W.; Dufresne, A. Novel Cellulose Fibre Reinforced Thermoplastic Materials. Cellulose 2006, 13, 271-280.
(6) Ruiz, M. M.; Cavaille, J. Y.; Dufresne, A.; Gerard, J. F.; Graillat, C. Processing and Characterization of New Thermoset Nanocomposites Based on Cellulose Whiskers. Composite Interfaces 2000, 7, 117-131.
(7) Marcovich, N. E.; Auad, M. L.; Bellesi, N. E.; Nutt, S. R.; Aranguren, M. I. Cellulose Micro/nanocrystals Reinforced Polyurethane. Journal of Materials Research 2006, 21, 870-881.
(8) Kalashnikova, I.; Bizot, H.; Bertoncini, P.; Cathala, B.; Capron, I. Cellulosic nanorods of various aspect ratios for oil in water Pickering emulsions. Soft Matter, 2013, 9, 952-9.
(9) Kalashnikova I.; Bizot H.; Cathala B.; Capron I. Modulation of cellulose nanocrystals amphiphilic properties to stabilize oil/water interface. Biomacromolecules, 2012, 13, 267-75.
(10) Liu, A.; Berglund, L. A. Fire-Retardant and Ductile Clay Nanopaper Biocomposites Based on Montmorrilonite in Matrix of Cellulose Nanofibers and Carboxymethyl Cellulose. European Polymer Journal 2013, 49, 940-9.
(11) Kalashnikova, I.; Bizot, H.; Cathala, B.; Capron I. New Pickering Emulsions Stabilized by Bacterial Cellulose Nanocrystals. Langmuir 2011, 27, 7471-9.
(12) Tohver, V.; Smay, J. E.; Braem, A.; Braun, P. V.; Lewis, J. A. Nanoparticle halos: A new colloid stabilization mechanism. PNAS 2001, 98, 8950-4.
(13) Zhang, F.; Long, G. G.; Jemian, P. R.; I Iavsky J.; Tohver, V.; Lewis, J. A. Quantitative Measurement of Nanoparticle Halo Formation around Colloidal Microspheres in Binary Mixtures. Langmuir 2008, 24 6504-6508.
(14) Air Products, Epoxy Curing Agents and Modifiers Ancarez™ AR555 Waterborne Epoxy Resin Technical Bulletin, Pub. No. 125-10-020-US, 2010.
(15) Air Products, Waterborne Epoxy Curatives High performance. Low emissions. Cost-effective. Pub. No. 125-08-013-US, 2008.
(16) Ruiz, M. M.; Cavaille, J. Y.; Dufresne, A.; Gerard, J. F.; Graillat, C. New Waterborne Epoxy Coatings Based on Cellulose Nanofillers. Macromolecular Symposia 2001, 169, 211-222.
(17) Xu S.; Girouard, N.; Schueneman, G.; Shofner, M.; Meredith, J. C. Mechanical and Thermal Properties of Waterborne Epoxy Composites Containing Cellulose Nanocrystals. Polymer 2013, 54, 6589-98.
(18) Beck-Candanedo, S.; Roman, M.; Gray, D. G. Effect of Reaction Conditions on the Properties and Behavior of Wood Cellulose Nanocrystal Suspensions. Biomacromolecules, 2005, 6, 1048-1054.
(19) McGovern, M. E.; Kallury, K. M. R.; Thompson, M. Role of Solvent on the Silanization of Glass with Octadecyltrichlorosilane. Langmuir 1994, 10, 3607-3614.
(20) Kulkarni, S. A.; Mirji, S. A.; Mandale, A. B.; Gupta, R. P.; Vijayamohanan, K. P. Growth Kinetics and Thermodynamic Stability of Octadecyltrichlorosilane Self-Assembled Monolayer on Si (100) Substrate. Materials Letters 2005, 59, 3890-3895.
(21) Cha, K.; Kim, D. Investigation of the Tribological Behavior of Octadecyltrichlorosilane Deposited on Silicon. Wear 2001, 251, 1169-1176.
(22) Liu, Y.; Wolf, L. K.; Messmer, M. C. A Study of Alkyl Chain Conformational Changes in Self-Assembled n-Octadecyltrichlorosilane Monolayers on Fused Silica Surfaces. Langmuir 2001, 17, 4329-4335.
(23) Flinn, D. H.; Guzonas, D. A.; Yoon, R. Characterization of Silica Surfaces Hydrophobized by Octadecyltrichlorosilane. Colloids and Surfaces A: Physicochemical and Engineering Aspects 1994, 87, 163-176.
(24) Mirji, S. A.; Octadecyltrichlorosilane Adsorption Kinetics on Si(100)/SiO₂ Surface: Contact Angle, AFM, FTIR and XPS Analysis. Surface and Interface Analysis 2006, 38, 158-165.
(25) Dean, J. A. Lange's Handbook of Chemistry McGraw-Hill, 15^{th} edition, 1992.
(26) Araki, J.; Wada, M.; Kuga, S.; Okano, T. Flow Properties of Microcrystalline Cellulose Suspension Prepared by Acid Treatment of Native Cellulose. Colloids and Surfaces A: Physicochemical and Engineering Aspects 1998, 142, 75-82.
(27) Fengel, D.; Wegener G. Wood: Chemistry, Ultrastructure, Reactions Walter de Gruyter: New York, 1984.
(28) Landry, V.; Alemdar, A.; Blanchet, P. Nanocrystalline Cellulose: Morphological, Physical, and Mechanical Properties. Forest Products Journal 2011, 61, 104-112.
(29) Cranston, E. D.; Gray, D. G. Birefringence in Spin-Coated Films Containing Cellulose Nanocrystals. Colloids and Surfaces a-Physicochemical and Engineering Aspects 2008, 325, 44-51.
(30) Augersion, C. C.; Messinger, J. M. Controlling the Refractive Index of Epoxy Adhesives With Acceptable Yellowing After Aging. Journal of the American Institute for Conservation 1993, 32, 311-314.
(31) Mabrouk, A. B.; Vilar, M. R.; Magnin, A.; Belgacem, M. N.; Boufi, S. Synthesis and characterization of cellulose whiskers/polymer nanocomposite dispersion by mini-emulsion polymerization. Journal of Colloid and Interface Science 2011, 363, 129-136.
(32) Cui, Z. G.; Cui, C. F.; Zhu, Y.; Binks, B. P.; Multiple Phase Inversion of Emulsions Stabilized by in Situ Surface Activation of Caco3 Nanoparticles Via Adsorption of Fatty Acids. Langmuir 2012, 28, 314-320.
(33) Liao, Y. A Study of Glass Fiber-Epoxy Composite Interfaces. Polymer Composites 1989, 10, 424-428.
(34) Yeo, G. A.; Ford, T. A. Ab initio molecular orbital calculations of the infrared spectra of hydrogen bonded complexes of water, ammonia, and hydroxylamine. Part 6. The infrared spectrum of the water-ammonia complex. Canadian Journal of Chemistry 1990, 69, 632-637.
(35) Ansari, F.; Gallanda, S.; Johanssona, M.; Plummer, C. J. G., Berglund, L. A. Cellulose nanofiber network for moisture stable, strong and ductile biocomposites and increased epoxy curing rate. Composites: Part A 2014, 63, 35-44.
(36) Tang. L.; Weder, C. Cellulose Whisker/Epoxy Resin Nanocomposites. ACS Applied Materials and Interfaces 2010, 2, 1073-1080.
(37) Samir, M.; Alloin, F.; Dufresne, A. Review of Recent Research into Cellulosic Whiskers, Their Properties and Their Application in Nanocomposite Field. Biomacromolecules 2005, 6, 612-62.
(38) Capadona, J. R.; Van Den Berg, O.; Capadona, L. A.; Schroeter, M.; Rowan, J.; Tyler, D. J.; Weder, C. A versatile approach for the processing of polymer nanocomposites with selfassembled nanofibre templates. Nature Nanotechnology, 2007, 2, 765-9.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim:

1. A method of making a waterborne epoxide resin comprising:
mixing an epoxide suspension with cellulose to form mixture A;
stirring mixture A for about one hour or more; and
adding a protic crosslinker to mixture A and further stirring to form mixture B.

2. The method of claim 1, wherein the cellulose is cellulose nanocrystals.

3. The method of claim 2, wherein the cellulose is wood-based cellulose nanocrystals.

4. The method of claim 3, wherein the wood-based cellulose nanocrystals are freeze-dried.

5. The method of claim 1, wherein the cellulose is cellulose nanofibrils.

6. The method of claim 5, wherein the cellulose is wood-based cellulose nanofibrils.

7. The method of claim 6, wherein the wood-based cellulose nanofibrils are freeze-dried.

8. The method of claim 1, wherein the epoxide is selected from the group consisting of: bisphenol A diglycidyl ether, bisphenol-F diglycidyl ether, epoxy phenol novolacs or epoxy cresol novolacs, aliphatic or cycloaliphatic epoxides, and glycidyl amines.

9. The method of claim 1, wherein the epoxide is bisphenol A diglycidyl ether.

10. The method of claim 1, wherein the protic crosslinker includes a function group selected from the group consisting of: phenols, anhydrides, aromatic or aliphatic amines, carboxylic acids, acid anhydrides, thiols, and a combination thereof.

11. The method of claim 1, wherein the protic crosslinker is poly(oxypropylenediamine).

12. A method of making an epoxy/cellulose composite film comprising:
precuring mixture B of claim 1 at room temperature,
casting the mixture onto a silicon wafer solid substrate to form a coated substrate, and
curing the coated substrate in an oven to form the epoxy/cellulose film.

13. The method of claim 12, wherein the cellulose is about 0.01-20 wt. % of the epoxy/cellulose film.

14. A composition comprising:
a waterborne epoxide resin formed by: mixing an epoxide suspension with aqueous cellulose suspension to form mixture A; stirring mixture A for about one hour or more; adding a protic crosslinker to mixture A and further stirring to form mixture B, wherein the cellulose is about 0.01-20 wt. % of the of the waterborne epoxide resin, wherein the waterborne epoxide has a pot life of about 30 days or longer than waterborne epoxide formed using a single-step mixing process, and optionally has a work of fracture of about 50-150% greater than an epoxy formed using a single-step mixing process, and exhibits lower birefringence than the epoxy formed using a single-step mixing process.

15. The composition of claim 14, wherein the cellulose is cellulose nanocrystals or cellulose nanofibrils.

16. The composition of claim 15, wherein the cellulose is wood-based cellulose nanocrystals or cellulose nanofibrils.

17. The composition of claim 15, wherein the wood-based cellulose nanocrystals or cellulose nanofibrils are freeze-dried.
